(19) United States
(12) Patent Application Publication
(10) Pub. No.: US 2026/0146163 A1
(43) Pub. Date: May 28, 2026

(54) CHEMICAL- AND UV-RESISTANT SURFACING FILM MATERIAL AND PREPREGS

(71) Applicant: Hexcel Corporation, San Ramon, CA (US)

(72) Inventors: Matthew Cleaver, Duxford (GB); Jonathan Carson, Duxford (GB); Rebecca Haber, Salt Lake City, UT (US); Tucker McKenzie, Salt Lake City, UT (US); Matthew Warner, West Valley City, UT (US); Raymond Thibault, Amesbury, MA (US); Olivia Niitsoo, Salt Lake City, UT (US)

(21) Appl. No.: 19/374,133

(22) Filed: Oct. 30, 2025

Related U.S. Application Data
(60) Provisional application No. 63/725,071, filed on Nov. 26, 2024.

(51) Int. Cl. C09D 5/33; C08J 5/24; C08J 7/04; C08L 63/00; C09D 7/48; C09D 7/61; C09D 7/63; C09D 163/00

(52) U.S. Cl. CPC C09D 5/004; C08J 5/243; C08J 7/0427; C08L 63/00; C09D 7/48; C09D 7/61; C09D 7/63; C09D 163/00; C08J 2363/00; C08J 2461/04; C08J 2463/00

(57) ABSTRACT

Provided are curable coating compositions comprising epoxy resin, a UV reflectant, and optionally a light stabilizer component comprising a hindered amine, which have desirable UV and chemical resistance properties on composite materials when cured. Uncured and cured composite materials comprising a prepreg infused with the coating of the invention, such prepregs themselves, and methods of preparing such cured, coated composite materials, are also provided.

### CROSS-REFERENCE TO RELATED APPLICATION(S)

This application claims the benefit of and priority to U.S. Provisional Application No. 63/725,071, filed on Nov. 26, 2024, which is incorporated by reference herein in its entirety.

### FIELD

The present invention relates generally to resin-based chemical- and UV-resistant coatings for carbon fiber reinforced polymers (CFRP), or composite materials, and composite materials comprising said coatings.

### BACKGROUND

Carbon fiber reinforced polymers (CFRPs), or composite materials, are used for a variety of applications in which high strength, low density materials are useful, including aircraft components. These materials may be exposed to many different chemical environments, leading to degradation and a loss of performance if left unprotected. Specifically, with respect to aircraft, exposure to chemical environments such as solvents, jet fuel, and paint strippers are common. Harsh environments such as moisture, salt water, sunlight, and high- or low-temperature are also common, and can lead to damage of an unprotected CFRP. Surfacing film materials that protect the underlying structure from one or more of these potentially harmful environments or substances are highly sought after.

Additionally, there is a need for the surfacing film to be combined with the CRFP in the green (uncured) state to provide protection immediately after cure, reduce workflow steps, and remain permanently co-cured to the CFRP offering protection for the life of the part.

Accordingly, there still exists a need for improved compositions and prepregs made therefrom which can provide sufficient protection from chemical and UV degradation, and remain adhered to the CFRP even after exposure to the common chemicals and UV light. It is with this and other improvements in mind that the present invention is presented.

### SUMMARY

It has unexpectedly been found that when an epoxy-containing composition is prepared comprising certain UV reflectant and light stabilizer components, a composition with improved chemical and UV resistance on cured composite materials may be obtained. This composition may be infused into a fabric layer, to form a prepreg.

An embodiment of the invention is a surfacing composition comprising:
i) a curable resin component;
ii) at least one light stabilizer additive; and
iii) a UV reflectant;
wherein the curable resin component comprises an epoxy resin;
wherein the light stabilizer additive comprises a hindered amine compound.

Another embodiment is a cured or partially-cured surfacing composition as mentioned above.

Another embodiment is a prepreg, comprising a fabric impregnated or coated with the surfacing composition mentioned above.

Another embodiment is a co-curable composite assembly, comprising
i) a co-curable composite material layer, comprising a carbon fiber having an uncured or partially-cured resin matrix infused therein; and
ii) a first prepreg as mentioned above.

Another embodiment is a composite assembly, comprising
i) a composite material layer, comprising a carbon fiber having a cured or partially-cured resin matrix infused therein; and
ii) a first prepreg as mentioned above.

Another embodiment is a method of forming a co-cured composite assembly, said method comprising:
i) providing the co-curable composite assembly as mentioned above; and
ii) co-curing the co-curable composite assembly,
thereby forming a co-cured composite assembly

### BRIEF DESCRIPTION OF THE FIGURES

FIG. 1A depicts a surfacing composition-infused prepreg layer and composite material assembly. FIG. 1B depicts this assembly with an additional barrier layer.

FIG. 2A depicts a surfacing composition-infused prepreg layer and composite material assemblies further comprising a conductive layer. FIG. 2B depicts an assembly like that shown in FIG. 1B, with an additional conductive layer. FIGS. 2C and 2D depict assemblies like those in FIGS. 2A and 2B, respectively, in different configurations.

FIG. 3A depicts a surfacing composition-infused prepreg layer and composite material assembly further comprising a conductive layer and a second surfacing composition-infused prepreg layer. FIGS. 3B and 3C depict assemblies like those in FIG. 3A, with one or two barrier layers added, respectively.

### DETAILED DESCRIPTION

The present inventions now will be described more fully hereinafter. These inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise. All patents and patent application publications are hereby incorporated by reference in their entireties.

### I. Definitions

For the purposes of the present application, the following terms shall have the following meanings:

The terms “about” as used herein means a deviation (plus/minus) of less than 10%, and in particular, less than 5%, less than 4%, less than 3%, and less than 2% of the recited value.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 8-10%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “epoxy resin” refers to any resin comprising monomers containing at least one epoxide group prior to curing, or to a cured resin made from such monomers.

The term “ether resin” refers to any resin comprising monomers containing at least one ether group prior to curing, or to a cured resin made from such monomers.

The term “phenoxy resin” refers to any resin comprising monomers containing at least one phenoxy group prior to curing, or to a cured resin made from such monomers.

The term “hindered amine” refers to a secondary or tertiary amine in which, in a secondary amine, the nitrogen atom is bound to two tertiary carbon atoms, and in a tertiary amine, the nitrogen atom is bound to two tertiary carbon atoms and an alkyl group. A “primary amine” is a nitrogen with two hydrogens and one carbon bound thereto. A “secondary amine” is a nitrogen with one hydrogen and two carbons bound thereto. A “tertiary amine” is a nitrogen with three carbons bound thereto. A “tertiary carbon” is bound to three other carbon atoms.

Prepreg manufacture is a widely used technique in the manufacture of composite articles. Prepregs are widely used in e.g. aerospace, and for the construction of wind turbine blades. “Prepregs” comprise a layer of fiber reinforcement which has been impregnated with an uncured or partially cured matrix material. The term prepreg also includes so-called semipreg materials in which the matrix is bonded to the surface of the fibers of the reinforcement, but not so that the fibers are wet out, i.e. the matrix material is on the surface of the fibers and not fully dispersed throughout the reinforcement. The fiber may be selected from a wide range of materials, including carbon, glass, aramids or a combination of materials. The fiber may be woven or non-woven, and each layer of prepreg may have various fiber sub-layers within. These sub-layers may be at the same orientation (unidirectional) or at different orientations (bi-axial, tri-axial, multi-axial or in the form of non-crimped fabric), e.g. 0/+45/−45/90 degrees. The matrix material is generally a polymer and may be a thermoset (e.g. epoxy) or a thermoplastic material. Discussion of prepreg materials may be found in U.S. Pat. Nos. 10,472,479 and 9,868,266, and U.S. Pat. Pub. No. 2022/0009183, each of which are hereby incorporated by reference in their entirety.

Two or more materials that are “co-curable” may be cured simultaneously under common curing conditions, such as temperature, pressure, temperature profile, etc.

Other terms are defined below.

### 1. Curable Resin Component

The surfacing composition of the invention comprises at least one curable resin component. In a preferred embodiment, the surfacing composition comprises at least one epoxy resin. In an embodiment, the curable resin component is present in the composition in an amount of about 30-99.98% by weight. In an embodiment, the curable resin component is present in an amount of at least, at most, or about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98. 98.5, 99, 99.5, 99.6, 99.7, 99.8, 99.9, 99.95, or 99.98% by weight, or within a range defined by any two of these values.

The curable resin component may comprise more than one resin. In some embodiments, the curable resin component comprises at least 2, 3, 4, 5, 6, or 7 resins. The curable resin component may comprise more than one of each kind of resin (i.e., may contain more than one kind of epoxy resin, more than one kind of ether resin, etc.).

The epoxy resin in the curable resin component of the invention may be any epoxide-containing material known in the art. In an embodiment, the epoxy resin is an epoxy-containing copolymer, such as epoxy methacrylate, epoxy acrylate, epoxy ester, epoxy cyanate ester, and siloxane epoxy copolymers. In an embodiment, the epoxy-containing copolymer is an epoxy/urethane copolymer.

Examples of suitable epoxies include those disclosed in U.S. Pat. Nos. 4,409,288, 6,013,730, and 6,379,799, and U.S. Patent Pub. No. 2013/0224470, which are hereby incorporated by reference in their entireties. In an embodiment, the epoxy resin is bisphenol-based. In an embodiment, the epoxy resin is bisphenol A-based. In an embodiment, the epoxy resin is bisphenol F-based. In an embodiment, the epoxy resin is bisphenol S-based. In an embodiment, the epoxy resin is a novolac. In an embodiment, the epoxy resin is aliphatic. In an embodiment, the epoxy resin is alicyclic. In an embodiment, the epoxy resin is halogenated. In an embodiment, the epoxy resin is an epoxy-containing dicyclopentadiene, which may form a tricyclodecane-based structure when polymerized.

Specific epoxy resins suitable for use in the present invention include:
Bisphenol A based: EPON 828, EPON 825, EPON 826, EPON 830, Epon 834 (Hexion), DER 332 (Dow Chemical), Tactix 123 and Tactix 138 (Huntsman).
Bisphenol F based: Araldite GY 281/282/285 (Huntsman) and Rutapox 0158 (Bakelite).
Epoxyphenol novolac-based: DEN 431, DEN 428, DEN 439 (Dow Chemical), EPN 1138 and EPN 1139 (Huntsman).
Halogenated (brominated): Araldite LT 8049 (Huntsman), DER 542 (Dow Chemical).
Alicyclic epoxies: CY179-1 (Daicel), EHPE 3150 (Daicel) Araldite 175 (Huntsman), Epalloy 5000 (Huntsman).

Examples of the compounds having epoxy groups and urethane groups include urethane-modified epoxy resins. Examples include EPU-78-13S, EPU-6, EPU-11, EPU-15, EPU16A, EPU-16N, EPU-17T-6, EPU-1348 and EPU-1395 (Adeka Corporation) and Hydran CF-025 (DIC Corporation).

Examples of cyanate ester-based compounds include: Primaset© PT-30, DT-4000, BADCy, and METHYLCy, BA-200.

Examples of dicyclopentadiene-based compounds include XD-1000 and XD-1000-2L (Nippon Kayaku, Japan), Tactix® 556 and Tactix® 756 (Huntsman), and Epiclon HP-7200 series (DIC Corporation).

In an embodiment, the curable resin component comprises 100% epoxy resin by weight. In an embodiment, the curable resin component comprises 1-100%, 5-90%, 10-50%, or 15-30% epoxy resin by weight. In an embodiment, the curable resin component comprises at least, at most, or about 1, 5, 10, 15, 20, 25, 30, 35, 40, 45, 50, 55, 60, 65, 70, 75, 80, 85, 90, 95, or 100% epoxy resin by weight, or within a range defined by any two of these values.

### 2. Additional Resins

The curable resin component may comprise resins other than epoxy resin. An epoxy resin may also comprise other functional groups (such as, for example, ether groups).

In some embodiments, the curable resin component comprises an ether resin. In an embodiment, the ether resin is an ether-containing copolymer. In some embodiments, the ether resin is selected from the group consisting of bisphenol-A diglycidyl ether resin and, hydrogenated bisphenol-A diglycidyl ether resin.

In an embodiment, the curable resin component comprises 0-99% epoxy resin by weight. In an embodiment, the curable resin component comprises 0-99%, 5-75%, 10-50%, or 20-40% ether resin by weight. In an embodiment, the curable resin component comprises at least, at most, or about 0, 5, 10, 15, 20, 25, 30, 35, 40, 45, 50, 55, 60, 65, 70, 75, 80, 85, 90, 95, or 99% epoxy resin by weight, or within a range defined by any two of these values.

In some embodiments, the curable resin component comprises a phenoxy resin. In an embodiment, the ether resin is a phenoxy-containing copolymer.

In an embodiment, the curable resin component comprises 0-99% phenoxy resin by weight. In an embodiment, the curable resin component comprises 0-99%, 5-75%, 10-50%, or 20-40% phenoxy resin by weight. In an embodiment, the curable resin component comprises at least, at most, or about 0, 5, 10, 15, 20, 25, 30, 35, 40, 45, 50, 55, 60, 65, 70, 75, 80, 85, 90, 95, or 99% phenoxy resin by weight, or within a range defined by any two of these values.

### 3. Light Stabilizer Additive

In an embodiment, the surfacing composition comprises at least one light stabilizer additive. In an embodiment, the light stabilizer additive is a hindered amine compound. In an embodiment, the hindered amine compound has the structure

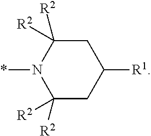

R¹ has the structure —R³ₐ—R⁴_{b}—R⁵_{c}—R⁶.

a, b, and c are each 0 or 1. In an embodiment, a is 1. In an embodiment, a is 0. In an embodiment, b is 1. In an embodiment, b is 0. In an embodiment, c is 1. In an embodiment, c is 0. In an embodiment, at least one of a, b, and c is 1.

Each R² is independently selected from the group consisting of C₁₋₆ alkyl and C₅₋₁₄ cycloalkyl. In an embodiment, each R² is independently C₁₋₆ alkyl. In an embodiment, each R² is independently C₁, C₂, C₃, C₄, C₅, or C₆ alkyl, or within a range defined by any two of these alkyls. Each alkyl may be linear or branched. In an embodiment, each R² is independently C₅₋₁₄ cycloalkyl. In an embodiment, each R² is independently C₅, C₆, C₇, C₈, C₉, C₁₀, C₁₁, C₁₂, C₁₃, or C₁₄ cycloalkyl, or within a range defined by any two of these cycloalkyls.

R³ is selected from the group consisting of —OC(O)—, —C(O)O—, C₁₋₆ alkyl, and C₅₋₁₄ cycloalkyl. In an embodiment, R³ is —OC(O)—. In an embodiment, R³ is —C(O)O—. In an embodiment, R³ is C₁₋₆ alkyl. In an embodiment, R³ is C₁, C₂, C₃, C₄, C₅, or C₆ alkyl, or within a range defined by any two of these alkyls. In an embodiment, R³ is C₅₋₁₄ cycloalkyl. In an embodiment, R³ is C₅, C₆, C₇, C₈, C₉, C₁₀, C₁₁, C₁₂, C₁₃, or C₁₄ cycloalkyl, or within a range defined by any two of these cycloalkyls.

R⁴ is C₁₋₁₆ alkyl. In an embodiment, R⁴ is C₁, C₂, C₃, C₄, C₅, C₆, C₇, C₈, C₉, C₁₀, C₁₁, C₁₂, C₁₃, or C₁₄ alkyl, or within a range defined by any two of these alkyls.

R⁵ is selected from the group consisting of —OC(O)—, —C(O)O—, C₁₋₆ alkyl, and C₅₋₁₄ cycloalkyl. In an embodiment, R⁵ is —OC(O)—. In an embodiment, R⁵ is —C(O)O—. In an embodiment, R⁵ is C₁₋₆ alkyl. In an embodiment, R⁵ is C₁, C₂, C₃, C₄, C₅, or C₆ alkyl, or within a range defined by any two of these alkyls. In an embodiment, R⁵ is C₅₋₁₄ cycloalkyl. In an embodiment, R⁵ is C₅, C₆, C₇, C₈, C₉, C₁₀, C₁₁, C₁₂, C₁₃, or C₁₄ cycloalkyl, or within a range defined by any two of these cycloalkyls.

R⁶ is selected from the group consisting of H, C₁₋₆ alkyl, C₅₋₁₄ cycloalkyl, and

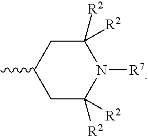

In an embodiment, R⁶ is H. In an embodiment, R⁶ is C₁₋₆ alkyl. In an embodiment, R⁶ is C₁, C₂, C₃, C₄, C₅, or C₆ alkyl, or within a range defined by any two of these alkyls. In an embodiment, R⁶ is C₅₋₁₄ cycloalkyl. In an embodiment, R⁵ is C₅, C₆, C₇, C₈, C₉, C₁₀, C₁₁, C₁₂, C₁₃, or C₁₄ cycloalkyl, or within a range defined by any two of these cycloalkyls.

In an embodiment, R⁶ is

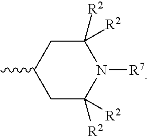

In an embodiment, R⁶ is

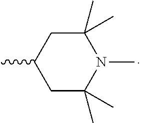

Each R⁷ is independently selected from the group consisting of H, C₁₋₆ alkyl and C₅₋₁₄ cycloalkyl. In an embodiment, R⁷ is C₁₋₆ alkyl. In an embodiment, R⁷ is C₁, C₂, C₃, C₄, C₅, or C₆ alkyl, or within a range defined by any two of these alkyls. Each alkyl may be linear or branched. In an embodiment, R⁷ is C₅₋₁₄ cycloalkyl. In an embodiment, R⁷ is C₅, C₆, C₇, C₈, C₉, C₁₀, C₁₁, C₁₂, C₁₃, or C₁₄ cycloalkyl, or within a range defined by any two of these cycloalkyls. In an embodiment, R⁷ is H. In an embodiment, R⁷ is methyl.

In an embodiment, the hindered amine compound has the structure

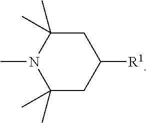

In an embodiment, the hindered amine has the following structure:

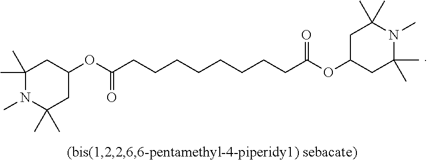

In an embodiment, the hindered amine has the following structure:

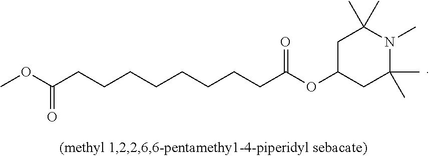

In an embodiment, the surfacing composition comprises bis(1,2,2,6,6-pentamethyl-4-piperidyl) sebacate and methyl 1,2,2,6,6-pentamethyl-4-piperidyl sebacate.

In an embodiment, the composition comprises at least two light stabilizer additives, each of which may be any light stabilizer additive described herein. In an embodiment, the surfacing composition comprises a first light stabilizer additive and a second light stabilizer additive in a weight ratio of 99.9:0.1 to 0.1-99.9. In an embodiment, the weight ratio is at least, at most, or about 99.9:0.1, 99.5:0.5, 99:1, 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95, 1:99, 0.5:99.5, or 0.1:99.9, or within a range defined by any two of these values. In an embodiment, the surfacing composition comprises two, three, four, five, six, seven or eight light stabilizer additives. In an embodiment, the weight ratio between any two light stabilizer additives is at least, at most, or about 99.9:0.1, 99.5:0.5, 99:1, 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95, 1:99, 0.5:99.5, or 0.1:99.9, or within a range defined by any two of these values.

In an embodiment, the light stabilizer additive has a molecular weight of less than 3,000 amu. In an embodiment, the light stabilizer additive has a molecular weight of 200-3,000 amu. In an embodiment, the light stabilizer additive has a molecular weight of about 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, or 3000 amu, or within a range defined by any two of these values.

In an embodiment, the at least one light stabilizer additive is present in an amount of 0-15% by weight. In an embodiment, the at least one light stabilizer additive is present in an amount of 0.001-15% by weight. In an embodiment, the at least one light stabilizer additive is present in an amount of 2-12% or 6-10% by weight. In an embodiment, the at least one light stabilizer additive is present in an amount of at least, at most, or about 0, 0.001, 0.005, 0.01, 0.05, 0.1, 0.5, 1, 2, 3, 4, 5, 6, 7, 8, 9, 10, 11, 12, 13, 14, or 15% by weight, or within a range defined by any two of these values. In an embodiment, the surfacing composition does not comprise a light stabilizer additive.

In an embodiment, the light stabilizer additive is a solid. In an embodiment, the light stabilizer additive is a liquid.

### 4. UV Reflectants

The UV reflectant is not specifically restricted, and can be any UV reflectant known in the art. One of or a combination of at least two UV reflectants can be used.

In an embodiment, the UV reflectant is selected from the group consisting of titanium dioxide (TiO₂), metal oxides, metal carbonates, metal silicates, and metal hydroxides.

In an embodiment, the UV reflectant is a metal oxide. In an embodiment, the metal oxide is selected from the group consisting of zirconium dioxide (ZrO₂, also known as zirconia), zinc oxide (ZnO), niobia (Nb₂O₅), aluminum oxide (Al₂O₃, also known as alumina), yttrium (III) oxide (Y₂O₃, also known as yttria), scandia (Sc₂O₃). and titanium oxides (TiO₂).

In an embodiment, the titanium oxide is titanium dioxide (TiO₂). In an embodiment, the TiO₂ is in particulate form. In an embodiment, the TiO₂ particles have a median particle size of 200-1000 nm. In an embodiment, the TiO₂ particles have a median particle size of at least, at most, or about 200, 250, 300, 350, 400, 450, 500, 550, 600, 650, 700, 750, 800, 850, 950, or 1000 nm, or within a range defined by any two of these values.

In an embodiment, the metal carbonate is calcium carbonate (CaCO₃).

In an embodiment, the UV reflectant is present in an amount of 0.001-30% by weight. In an embodiment, the UV reflectant is present in an amount of 2-12% or 6-10% by weight. In an embodiment, the UV reflectant is present in an amount of at least, at most, or about 0.001, 0.005, 0.01, 0.05, 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight, or within a range defined by any two of these values.

### 5. UV Absorbers

In some embodiment, the surfacing composition further comprises a benzotriazole-based UV absorber. The UV absorber is not specifically restricted, and can be any UV absorber comprising a benzotriazole moiety known in the art. One of or a combination of at least two UV absorbants can be used. In an embodiment, the UV absorber is Everstab 234 (Everspring Chemical, Los Angeles, CA).

In an embodiment, the UV absorber is a solid. In an embodiment, the UV absorber is a liquid.

In an embodiment, the UV absorber is present in an amount of 0-5% by weight. In an embodiment, the UV absorber is present in an amount of at least, at most, or about 0, 0.001, 0.005, 0.01, 0.05, 0.1, 0.2, 0.3, 0.4, 0.5, 1, 1.5, 2, 2.5, 3, 3.5, 4, 4.5, or 5% by weight, or within a range defined by any two of these values. In an embodiment, the surfacing composition does not comprise a benzotriazole-based UV absorber.

### 6. Additional Components

The surfacing composition may include one or more additional components, in addition to those described above.

In some embodiments, the surfacing composition comprises a filler. The filler may be any filler suitable for use in curable resins. In an embodiment, the filler is selected from the group consisting of wollastonite (CaSiO₃), clays (including but not limited to kaolin, montmorillonite, and dragonite), calcium carbonate, glass beads (solid or hollow), glass flake, tabular alumina, and talc.

When the filler includes wollastonite, the wollastonite may be in any form suitable for inclusion in curable resins. Without being bound by theory, the wollastonite may provide increased chemical resistance to the coating composition, by virtue of its needle-like particles having high aspect ratios (defined as the ratio of the length of the particle to the width of the particle). In an embodiment, the wollastonite may have an average aspect ratio of 3:1-20:1. In an embodiment, the wollastonite may have an average aspect ratio of at least, at most, or about 3:1, 4:1, 5:1, 6:1, 7:1, 8:1, 9:1, 10:1, 11:1, 12:1, 13:1, 14:1, 15:1, 16:1, 17:1, 18:1, 19:1, or 20:1, or within a range defined by any two of these values.

In some embodiments, the filler is present in an amount of 0-75% by weight. In an embodiment, the filler is present in an amount of at least, at most, or about 0, 0.001, 0.01, 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75% by weight, or within a range defined by any two of these values.

In some embodiments, the surfacing composition comprises silica (SiO₂). In an embodiment, the silica is fumed silica. In some embodiments, silica is present in an amount of 0-10%, 0-5%, or 1-3% by weight. In an embodiment, silica is present in an amount of at least, at most, or about 0, 0.001, 0.01, 0.1, 0.5, 1, 2, 3, 4, 5, 6, 7, 8, 9, or 10% by weight, or within a range defined by any two of these values.

In some embodiments, the surfacing composition comprises at least one hardener. The hardener may be any hardener suitable for use with the resins of the surfacing composition. In an embodiment, the hardener is a resin hardener. In an embodiment, the hardener is an epoxy hardener. Suitable epoxy hardeners include, but are not limited to, dicyanamide (such as Dyhard 100 M (DICY) sold by AlzChem (Trostberg, Germany)), a dihydrazide (non-limiting examples of which include adipic dihydrazide, isophthalic dihydrazide, and vinyl dihydrazide), isophorone diamine, and hexamethylene diamine.

In some embodiments, the hardener is present in an amount of 0-20%, 0-10%, or 0-5%, or 3-5% by weight. In an embodiment, the hardener is present in an amount of at least, at most, or about 0, 0.001, 0.01, 0.1, 0.5, 1, 2, 3, 4, 5, 6, 7, 8, 9, 10, 11, 12, 13, 14, 15, 16, 17, 18, 19, or 20% by weight, or within a range defined by any two of these values.

In some embodiments, the surfacing composition comprises at least one accelerator. In an embodiment, the accelerator is a tertiary amine-based or imidazole-based molecule. Suitable accelerators include, but are not limited to, Curezol 2PHZ-PW (2-phenyl-1H-imidazole-4,5-dimethanol, available from Evonik, Greensboro, NC), Curezol 2P4MZ (4-methyl-2-phenyl-1H-imidzaole, available from Evonik), tris(2-pyridylmethyl)amine, 1,4-diazabicyclo[2.2.2]octane, tributylamine, N,N-dimethylbenzylamine, triethanolamine, 2,4,6-tris(dimethylaminomethyl) phenol, and a dihydrazide. In an embodiment, the dihydrazide is selected from the group consisting of adipic dihydrazide, isophthalic dihydrazide, and vinyl dihydrazide.

In some embodiments, the accelerator is present in an amount of 0-10%, 0-5%, 5-8%, or 3-5% by weight. In an embodiment, the accelerator is present in an amount of at least, at most, or about 0, 0.001, 0.01, 0.1, 0.5, 1, 2, 3, 4, 5, 6, 7, 8, 9, or 10% by weight, or within a range defined by any two of these values.

### 7. Prepregs Comprising the Surfacing Composition

In an embodiment, the surfacing compositions described herein are infused into a fiber or fabric to form a prepreg. The fabric may be any material suitable for forming a resin-based prepreg known in the art. Said fabric may comprise carbon, glass, polyolefins (including but not limited to polyester), aramids (aromatic polyamides), or a combination of materials. The fabric may be woven or non-woven, and each layer of prepreg may have various fiber sub-layers within. These sub-layers may be at the same orientation (unidirectional) or at different orientations (bi-axial, tri-axial, multi-axial or in the form of non-crimped fabric), e.g. 0/+45/−45/90 degrees. In a preferred embodiment, the fabric is a glass woven fabric. In an embodiment, the fabric is translucent.

### 8. Methods, Barriers, and Multi-Layer Assemblies

To form composite materials using the surfacing compositions and prepregs of the invention, a prepreg comprising the surfacing composition may be in contact with an uncured or partially-cured composite material to form a multi-layer assembly. The composite material will generally comprise a carbon fiber having an uncured or partially-cured resin matrix infused therein. The resin matrix is preferably an epoxy resin matrix. Composite materials are described in more detail in U.S. Pat. Pub. No. 2018/0023244 and U.S. Pat. No. 8,263,503, each of which is hereby incorporated by reference in their entirety.

In some embodiments, the multi-layer assembly may also comprise a conductive layer. The conductive layer may comprise any suitable conductive material used in aircraft, such as but not limited to aluminum, expanded copper foil, and interwoven wire fabric. The metals in the interwoven wire fabric could be metals including Ni/Cu and phosphor/bronze. Additional information on exemplary conductive layers may be found in U.S. Pat. No. 7,972,983, the contents of which are hereby incorporated by reference in their entirety.

In some embodiments, the prepreg comprising the surfacing composition will be directly in contact with the uncured or partially-cured composite material and/or the conductive layer. In other embodiments, there may be a barrier layer disposed between the prepreg comprising the surfacing composition and the uncured or partially-cured composite material and/or the conductive layer.

In some cases, the surfacing composition in the prepreg and the composite material may have similar or identical base chemistries (such as epoxy chemistry). This makes it possible for components in the composite material-which can be prone to yellowing under UV exposure—to diffuse into the prepreg layer. The barrier layer serves to reduce or prevent this diffusion. It is desirable to use a barrier layer that reduces or prevents diffusion while still exhibiting good adhesion to the layers on either side of the barrier layer. The barrier layer may be made of any material that exhibits these properties.

In some embodiments, the barrier layer comprises a metal, a ceramic, a polymer, or combinations thereof. In some embodiments, the polymer is selected from the group consisting of a polyolefin, a polyester, a polyimide, a polyether, a polyhydroxyl ether, a phenoxy, polyamide, a polyethylene, and combinations and copolymers thereof. In some embodiments, the polyether is a polyhydroxyl ether or a polyphenoxy ether. In some embodiments, the polyester is a polyethylene terephthalate. In some embodiments, the metal is a metal foil. In an embodiment, the metal is aluminum. In an embodiment, the metal is an aluminum foil.

In some embodiments, the barrier layer comprises a metal layer in contact with a polymer layer. In some embodiments, the barrier layer comprises an aluminum layer in contact with a polymer layer. In some embodiments, the barrier layer comprises an aluminum foil layer in contact with a polyimide layer. In an embodiment, the barrier layer comprises a metal foil layer and a polymer layer, oriented so that the metal foil layer is in contact with the prepreg comprising the surfacing composition.

In some embodiments, the barrier layer has a thickness of 1-500 microns. In some embodiments, the barrier layer has a thickness of at least, at most, or about 1, 5, 10, 20, 30, 40, 50, 60, 70, 80, 90, 100, 150, 200, 250, 300, 350, 400, 450, or 500 microns, or within a range defined by any two of these values. In some embodiments, the barrier layer has a thickness of 10-50 microns, or 20-30 microns.

In some embodiments, the barrier layer has an areal weight of 1-100 gsm (grams per square meter). In some embodiments, the barrier layer has an areal weight of at least, at most, or about 1, 5, 10, 15, 20, 25, 30, 35, 40, 45, 50, 55, 60, 65, 70, 75, 80, 85, 90, 95, or 100 gsm, or within a range defined by any two of these values. In some embodiments, the barrier layer has an areal weight of 10-75 gsm, or 20-60 gsm, or 30-50, or 30-40 gsm.

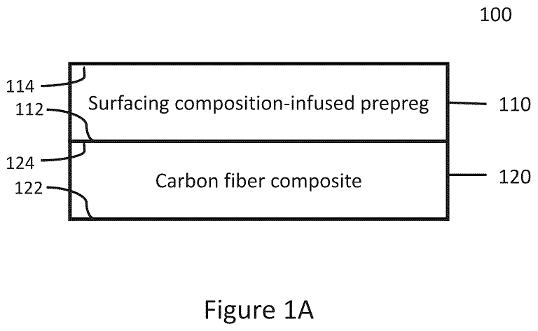

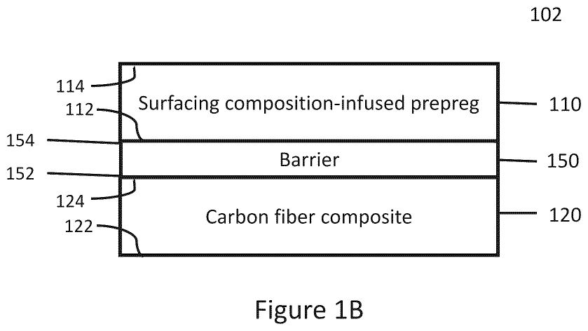

FIG. 1A depicts one exemplary multi-layer assembly 100. A surfacing composition-infused prepreg layer 110 as described hereinabove is in contact with a composite layer 120. The prepreg layer 110 comprises a first side 112 and a second side 114. The composite layer 120 comprises a first side 122 and a second side 124. The first side 112 of the prepreg layer 110 is disposed on the second side 124 of the composite layer 120. FIGS. 1-3 generally depict the assemblies with the exterior of the aircraft which they would be used to form at the top of the figure, and the interior of the aircraft at the bottom of the figure.

FIG. 1B depicts another exemplary multi-layer assembly 102. This multi-layer assembly is similar to the assembly shown in FIG. 1A, except with a barrier layer 150 disposed between the prepreg layer 110 and the composite layer 120. The barrier layer 150 has a first side 152 which is in contact with the second side 124 of the composite layer 120, and a second side 154 which is in contact with the first side 112 of the prepreg layer 110. In such an assembly wherein the barrier layer 150 comprises a metal foil layer and a polymer layer, it is preferred that the first side 152 of the barrier layer 150 contains the polymer layer, and the second side 154 contains the metal foil.

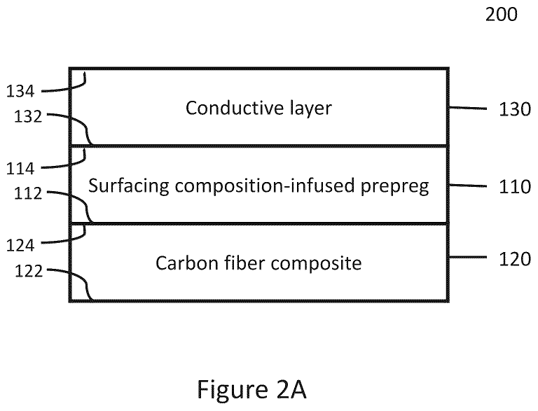

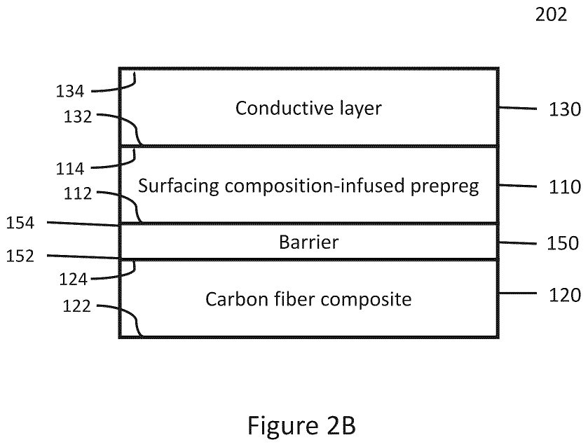

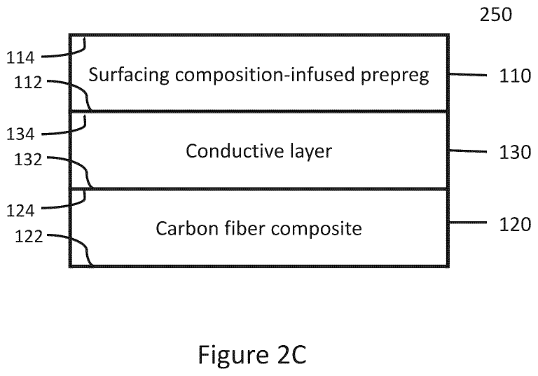

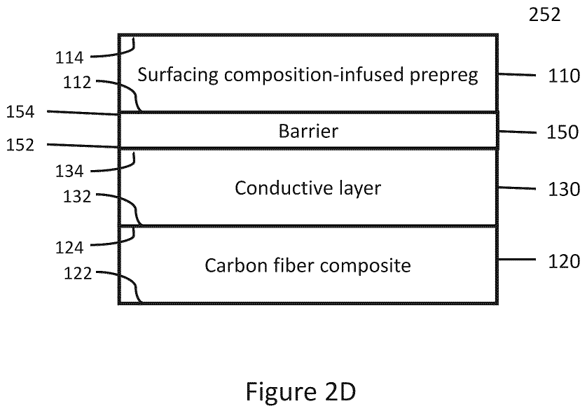

FIG. 2A depicts another exemplary multi-layer assembly 200, similar to the assembly 100 shown in FIG. 1A, but comprising an additional conductive layer 130. As in FIG. 1A, a surfacing composition-infused prepreg layer 110 as described hereinabove is in contact with a composite layer 120. The prepreg layer 110 comprises a first side 112 and a second side 114. The composite layer 120 comprises a first side 122 and a second side 124. The first side 112 of the prepreg layer 110 is disposed on the second side 124 of the composite layer 120. The conductive layer 130 comprises a first side 132 and a second side 134. The first side 132 of the conductive layer 130 is disposed on the second side 114 of the prepreg layer 110.

FIG. 2B depicts another exemplary multi-layer assembly 202, similar to the assembly 102 shown in FIG. 1B, but comprising an additional conductive layer 130. As in FIG. 1B, the conductive layer 130 comprises a first side 132 and a second side 134. The first side 132 of the conductive layer 130 is disposed on the second side 114 of the prepreg layer 110.

FIG. 2C depicts another exemplary multi-layer assembly 250, having the same three layers in the same orientation as that in FIG. 2A, but with the conductive layer 130 disposed between the prepreg layer 110 and the composite layer 120. The first side 132 of the conductive layer 130 is in contact with the second side 124 of the composite layer 120, and the second side 134 of the conductive layer 130 is in contact with the first side 112 of the prepreg layer 110.

FIG. 2D depicts another exemplary multi-layer assembly 252, having the same layers in the same configuration as in FIG. 2C, but with a barrier layer 150 disposed between the prepreg layer 110 and the conductive layer 130. The first side 152 of the barrier layer 150 is in contact with the second side 134 of the conductive layer, and the second side 154 of the barrier layer 150 is in contact with the first side 112 of the prepreg layer 110. In such an assembly wherein the barrier layer 150 comprises a metal foil layer and a polymer layer, it is preferred that the first side 152 of the barrier layer 150 contains the polymer layer, and the second side 154 contains the metal foil.

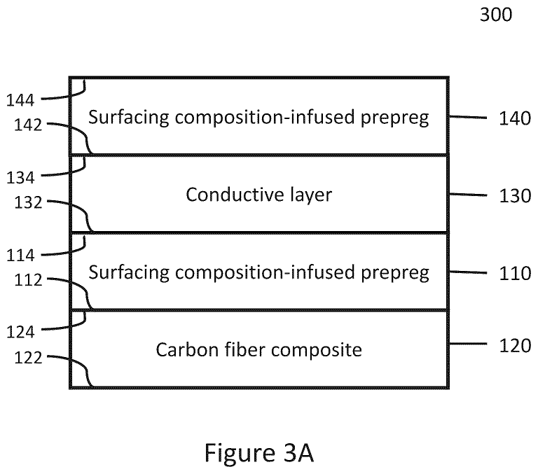

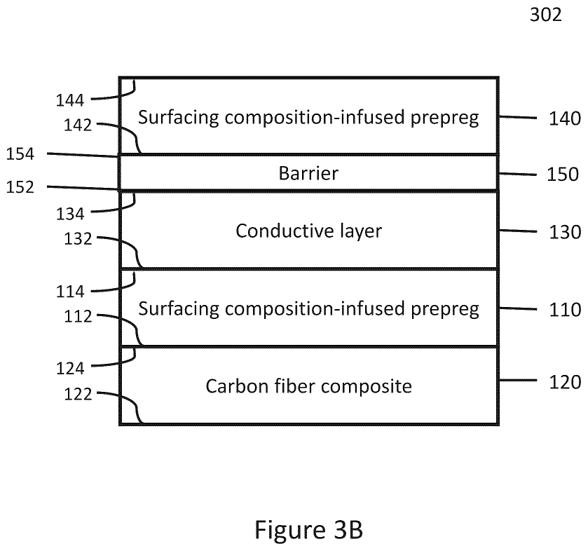

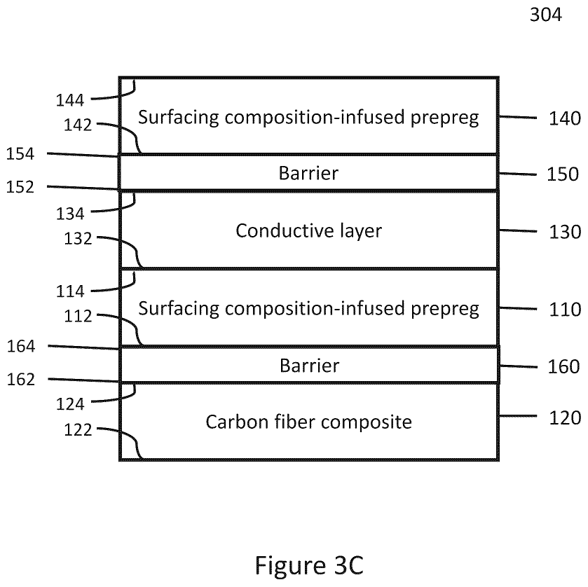

FIG. 3A depicts another exemplary multi-layer assembly 300, comprising a second surfacing composition-infused prepreg layer 140. As in FIG. 2A, a first surfacing composition-infused prepreg layer 110 as described hereinabove is in contact with a composite layer 120. The first prepreg layer 110 comprises a first side 112 and a second side 114. The composite layer 120 comprises a first side 122 and a second side 124. The first side 112 of the first prepreg layer 110 is disposed on the second side 124 of the composite layer 120. The conductive layer 130 comprises a first side 132 and a second side 134. The first side 132 of the conductive layer 130 is disposed on the second side 114 of the first prepreg layer 110. The second prepreg layer 140 comprises a first side 142 and a second side 144. The first side 142 of the second prepreg layer 140 is disposed on the second side 134 of the conductive layer 130. The first prepreg layer 110 and the second prepreg layer 140 may be different (such as having different surfacing compositions, different fabrics, or both) or the same.

FIG. 3B depicts another exemplary multi-layer assembly 302, having the same layers in the same configuration as in FIG. 3A, but with a first barrier layer 150 disposed between the second prepreg layer 140 and the conductive layer 130. The first side 152 of the first barrier layer 150 is in contact with the second side 134 of the conductive layer 130, and the second side 154 of the first barrier layer 150 is in contact with the first side 142 of the second prepreg layer 140. FIG. 3C depicts another exemplary multi-layer assembly 302, having the same layers in the same configuration as in FIG. 3B, but with a second barrier layer 160 disposed between the first prepreg layer 110 and the composite layer 120. The first side 162 of the second barrier layer 160 is in contact with the second side 124 of the composite layer 120, and the second side 164 of the second barrier layer 160 is in contact with the first side 112 of the first prepreg layer 110.

### DISCUSSION AND EXAMPLES

A number of tests were performed to evaluate various properties of films made from surfacing compositions of the invention. These tests included a pencil hardness test (using the test method described in ASTM D3363-22, to measure chemical resistance, as measured by the change in hardness), two colorimetry tests (using the method described in ASTM E1164 to test CIE color spectrum measurement, reported in CIE LAB format, and the method described in ASTM D2244-22 to obtain a color difference measurement, reported as ΔE), a cross-hatch adhesion test (using the method described in ASTM D3359-23, to test paint adhesion), and a UV irradiation test, described in more detail below, to test the effects of extended UV exposure.

### Materials

Resins tested include hydrogenated bisphenol-A diglycidyl ether resin (sold as Epalloy 5000 by Azelias Americas, Ohio), bisphenol A diglycidyl ether resin (sold as DER 332 by Olin Epoxy (Georgia)), dicyclopentadiene epoxy resins (sold as XD-1000 or XD-1000-2L by Nippon Kayaku (Tokyo, Japan)), cycloaliphatic epoxy resin (sold as EHPE 3150 by Daicel (Tokyo, Japan), polyglycidyl ether resin (sold as Epotec RD 129 by Aditya Birla (Kentucky)), phenolic novolac cyanate ester resin (sold as Primaset PT-30 by Arxada (New Jersey)), a toughened cyanate ester resin (sold as Primaset DT-7000 by Arxada), and micronized phenoxy resin (sold as Phenoxy PKHP-200 by Huntsman (Texas))

Dicyandiamide was available as Dyhard 100 M (DICY) or Dyhard 100SH (DICY) by AlzChem (Trostberg, Germany). Fumed silica was available as Cabosil TS 720 or Cabosil M5 from Cabot, Massachusetts. Wollastonite was obtained as either NYLITE 4W from Imerys (New York) or as Vanasil HR-1500 from Vanderbilt Minerals (New York). Titanium dioxide was obtained as Ti-Pure R-104, Ti-Pure R-103, Ti-Pure R-350, or Ti-Pure R-706 from Chemours (Delaware). Calcium carbonate was obtained as Omyaset UF-FL from Omya (Switzerland). A hindered amine light stabilizer (an oligomer of 2,2,4,4-tetramethyl-7-oxa-3,20-diazadispiro[5.1.11.2]-heneicosan-21-on and epichlorohydrin) was sold as Hostavin 3070P by Clariant (California). A blend of hindered amine light stabilizers (bis(1,2,2,6,6-pentamethyl-4-piperidyl) sebacate and methyl 1,2,2,6,6-pentamethyl-4-piperidyl sebacate) was sold as Eversorb EP4S by Everlight Chemical (Taipei, Taiwan). A benzotriazole UV absorber (2-[2-hydroxy-3,5-di(1,1-dimethylbenzyl)phenyl]2H-benzotriazole) was sold as Everstab 234 by Everspring Chemical (California). A cure rate accelerator was sold as Technicure ADH-J (A&C Catalysts, Inc., Linden, NJ).

Formulations tested include, but are not limited to, the following (all percentages listed are by weight):
Formulation A: Epalloy 5000 diglycidyl ether resin (5%), DER 332 diglycidyl ether resin (35.6%), XD-1000-2L dicyclopentadiene epoxy resin (16%), Phenoxy PKHP-200 micronized phenoxy resin (14%), Dyhard 100 M dicyandiamide (3.4%), Cabosil TS 720 fumed silica (2%), NYLITE 4W wollastonite (20%), carbon black (0.1%), Ti-Pure R-104 titanium dioxide (3.9%).
Formulation B: Epalloy 5000 diglycidyl ether resin (5%), DER 332 diglycidyl ether resin (35.6%), XD-1000 dicyclopentadiene epoxy resin (16%), Phenoxy PKHP-200 micronized phenoxy resin (14%), Dyhard 100 M dicyandiamide (3.4%), Cabosil TS 720 fumed silica (2%), kaolin (20%), carbon black (0.1%), Ti-Pure R-104 titanium dioxide (3.9%).
Formulation C: Epalloy 5000 diglycidyl ether resin (5%), DER 332 diglycidyl ether resin (35.6%), XD-1000-2L dicyclopentadiene epoxy resin (16%), Phenoxy PKHP-200 micronized phenoxy resin (14%), Dyhard 100 M dicyandiamide (3.4%), Cabosil TS 720 fumed silica (2%), NYLITE 4W wollastonite (20%), Ti-Pure R-104 titanium dioxide (4%).
Formulation D: Epalloy 5000 diglycidyl ether resin (4.9%), DER 332 diglycidyl ether resin (33.9%), XD-1000-2L dicyclopentadiene epoxy resin (15.3%), Phenoxy PKHP-200 micronized phenoxy resin (13.3%), Dyhard 100 M dicyandiamide (3.3%), NYLITE 4W wollastonite (15.3%), Ti-Pure R-350 titanium dioxide (4%), Hostavin 3070P hindered amine light stabilizer (10%).
Formulation E: Epalloy 5000 diglycidyl ether resin (4.9%), DER 332 diglycidyl ether resin (33.9%), XD-1000-2L dicyclopentadiene epoxy resin (15.3%), Phenoxy PKHP-200 micronized phenoxy resin (13.3%), Dyhard 100 M dicyandiamide (3.3%), NYLITE 4W wollastonite (15.3%), Ti-Pure R-350 titanium dioxide (4%), Eversorb EP4S hindered amine light stabilizer (10%).
Formulation F: Epalloy 5000 diglycidyl ether resin (5%), DER 332 (35.6%), XD-1000-2L dicyclopentadiene epoxy resin (16%), Phenoxy PKHP-200 micronized phenoxy resin (14%), Dyhard 100 M dicyandiamide (3.4%), Vanasil HR-1500 wollastonite (16%), Ti-Pure R-350 titanium dioxide (10%).
Formulation G: Epalloy 5000 diglycidyl ether resin (5%), DER 332 diglycidyl ether resin (26.2%), XD-1000-2L dicyclopentadiene epoxy resin (16%), Phenoxy PKHP-200 micronized phenoxy resin (14%), Dyhard 100 M dicyandiamide (2.8%), Vanasil HR-1500 wollastonite (16%), Ti-Pure R-350 titanium dioxide (4%), Eversorb EP4S hindered amine light stabilizer (10%).
Formulation H: Epalloy 5000 diglycidyl ether resin (5%), DER 332 diglycidyl ether resin (26.25%), XD-1000-2L dicyclopentadiene epoxy resin (15%), Phenoxy PKHP-200 micronized phenoxy resin (13%), Dyhard 100 M dicyandiamide (2.75%), Vanasil HR-1500 wollastonite (16%), Ti-Pure R-350 titanium dioxide (10%), Eversorb EP4S hindered amine light stabilizer (5%), Omyaset UF7-FL calcium carbonate (7%).
Formulation I: EHPE 3150 cycloaliphatic epoxy resin (32.81%), Epotec RD-129 polyglycidyl ether resin (14.06%), Phenoxy PKHP-200 micronized phenoxy resin (7.3%), Dyhard 100 M dicyandiamide (3.29%), Cabosil TS 720 fumed silica (2%), Vanasil HR-1500 wollastonite (15%), Ti-Pure R-350 titanium dioxide (10%), Eversorb EP4S hindered amine light stabilizer (0.5%), Everstab 234 UV absorber (2.5%), Primaset PT-30 cyanate ester resin (12.54%).
Formulation J: EHPE 3150 cycloaliphatic epoxy resin (34.34%), Epotec RD-129 polyglycidyl ether resin (14.72%), Dyhard 100 M dicyandiamide (3.44%), Cabosil TS 720 fumed silica (2%), Vanasil HR-1500 wollastonite (15%), Ti-Pure R-350 titanium dioxide (10%), Hostavin 3070P hindered amine light stabilizer (0.5%), Everstab 234 UV absorber (2.5%), Primaset DT-7000 cyanate ester resin (17.5%).
Formulation K: EHPE 3150 cycloaliphatic epoxy resin (13.23%), DER 332 diglycidyl ether resin (39.69%), Phenoxy PKHP-200 micronized phenoxy resin (11.60%), Dyhard 100 SH dicyandiamide (3.72%), Cabosil M5 fumed silica (1.75%), Vanasil HR-1500 wollastonite (20%), Ti-Pure R-350 titanium dioxide (10%).
Formulation L: EHPE 3150 cycloaliphatic epoxy resin (13.36%), DER 332 diglycidyl ether resin (40.08%), Phenoxy PKHP-200 micronized phenoxy resin (9.05%), Dyhard 100 SH dicyandiamide (3.76%), Technicure ADJ-J (2.01%), Cabosil M5 fumed silica (1.75%), Vanasil HR-1500 wollastonite (20%), Ti-Pure R-350 titanium dioxide (10%).

### Example 1—Pencil Hardness Test for Kaolin and Wollastonite

A pencil hardness test was performed to determine which of kaolin and wollastonite would enable a surfacing film to better withstand degradation by hydraulic fluid. Two different films were prepared using nearly identical formulations, except that one comprised kaolin (Formulation B) and one comprised wollastonite (Formulation A), and a slightly different epoxy resin was used. These films were soaked for extended periods of time in hydraulic fluid (Skydrol (obtained from Eastman (Tennessee), commonly used with aircraft). A summary of the pencil hardness results is shown in Table 1 below. The hardness scale goes from 2H to 9H (hardest).

TABLE 1
Summary of pencil hardness results of formulation
using either kaolin or Wollastonite

| | Kaolin formulation | Wollastonite |
|---|---|---|
| Days | (Formulation B) | (Formulation A) |
| 0 | 8H | 8H |
| 18 | 7H | 8H |
| 28 | 7H | 8H |

The wollastonite-based surfacing film showed excellent resistance to hydraulic fluid soak when submerged for 28-days. Specifically, formulations using wollastonite as the inorganic mineral showed improved chemical resistance as evidenced by no knockdown in pencil hardness after exposure to hydraulic fluid.

### Example 2—Chemical Resistance Tests

Other formulations described above were tested using the same methodology as in Example 1 to test the resistance of the cured films to Skydrol, benzyl alcohol, and jet fuel, both before and after submersion, and in the presence of and absence of UVA exposure. The results are summarized in Table 2 below.

TABLE 2
Summary of pencil hardness results of formulations based on Skydrol,
benzyl alcohol, and jet fuel exposure, with no UV exposure

| | Pencil hardness results of formulation - no UV exposure | | | | | |
|---|---|---|---|---|---|---|
| | Skydrol | | Benzyl alcohol | | Jet fuel | |
| Form. | 0 days | 30 days | 0 days | 2 days | 0 days | 14 days |
| A | >9 H | >9 H | >9 H | >9 H | >9 H | >9 H |
| C | >9 H | >9 H | >9 H | >9 H | >9 H | >9 H |
| F | >9 H | >9 H | >9 H | >9 H | >9 H | >9 H |
| G | >9 H | >9 H | >9 H | 8 H | >9 H | >9 H |
| H | >9 H | >9 H | >9 H | >9 H | >9 H | >9 H |

TABLE 3
Summary of pencil hardness results of formulations
based on Skydrol, benzyl alcohol, and jet fuel exposure,
with 200 kJ/m² UV exposure

| | Pencil hardness results of formulation - 200 kJ/m² UV exposure | | | | | |
|---|---|---|---|---|---|---|
| | Skydrol | | Benzyl alcohol | | Jet fuel | |
| Form. | 0 days | 30 days | 0 days | 2 days | 0 days | 14 days |
| A | >9 H | >9 H | >9 H | >9 H | >9 H | >9 H |
| C | >9 H | >9 H | >9 H | >9 H | >9 H | >9 H |
| F | >9 H | >9 H | >9 H | >9 H | >9 H | >9 H |
| G | >9 H | 9 H | >9 H | >9 H | >9 H | >9 H |
| H | >9 H | >9 H | >9 H | >9 H | >9 H | >9 H |

### Example 3—Crosshatch Adhesion Test

Crosshatch adhesion testing was performed using a modified method described in ASTM D3359-23 on a surfacing film prepared from Formulation C following exposure to UV radiation using a series of Q-lab UVA-340 lamps. The modifications include a 45° angled crosshatch and reporting of the score on a 1-10 scale. Laminates were co-cured onto primary structure composites, to test how well the surfacing film adhered to the primary structure during the curing process, and to test how the co-curing was affected by UV and water exposure. The surfacing film showed excellent crosshatch adhesion scores before and after irradiation.

Specifically, cured laminates showed no change in crosshatch adhesion score indicated by an average score of 9 or 10 before and after UV-exposure followed by additional environmental conditioning detailed in Table 4. Scores over 7 are indicated as passing the test with 10 being the highest achievable score. A summary of the results is shown in Table 2 below.

TABLE 4
Summary of cross hatch adhesion score on laminates consisting
of the surfacing film co-cured with an epoxy-based primary structure
composite at zero (no UV exposure), 400 kJ/m², and 1000
kJ/m² irradiation levels followed by post-UV exposure conditioning
in different environments.

| Exposure | Post-UV exposure conditioning | | | |
|---|---|---|---|---|
| level | None | 7-day water soak | 3-day 160° F. | 3-day −10° F. |
| 0 | 10 | 9 | 10 | 10 |
| 400 kJ/m² | 10 | 10 | 10 | 10 |
| 1000 kJ/m² | 10 | 10 | 10 | 10 |

A summary of additional testing performed on other formulations, both dry and after a 7-day water soak, is shown in Tables 5 and 6 below, respectively.

TABLE 5
Summary of cross-hatch adhesion testing
for dry co-cured composites.

| | Cross hatch adhesion score after | | | |
|---|---|---|---|---|
| | different UV exposure levels | | | |
| Formulation | 0 kJ/m² | 200 kJ/m² | 400 kJ/m² | 1000 kJ/m² |
| A | 10 | 10 | 10 | 10 |
| C | 10 | 10 | 10 | 10 |
| F | 10 | 10 | 10 | 10 |
| G | 10 | 10 | 10 | 10 |
| H | 10 | 10 | 10 | 10 |

TABLE 6
Summary of cross-hatch adhesion testing for
co-cured composites after a 7-day water soak.

| | Cross hatch adhesion score after | | | |
|---|---|---|---|---|
| | different UV exposure levels | | | |
| Formulation | 0 kJ/m² | 200 kJ/m² | 400 kJ/m² | 1000 kJ/m² |
| A | 10 | 10 | 10 | 10 |
| C | 9 | 10 | 10 | 10 |
| F | 10 | 10 | 10 | 10 |
| G | 10 | 9 | 10 | 10 |
| H | 10 | 9 | 9 | 9 |

### Example 4—Color Change Values Tested Using ASTM D2244-22

Surfacing films cured on aluminum coupons showed significant improvement in UV-resistance determined by low ΔE values when a UV-absorber was used, where ΔE represents yellowing of the film. Specifically, formulations that comprised 10% EP4S showed the lowest ΔE value compared to all other formulations. Importantly, the type of UV absorber is significant as evidenced by the poor performance when 10% 3070P was used. The results are summarized in Table 7 below. The same base resin formulation was used in these examples (Formulation C, but with the 4% R-104 replaced by the UV resistant component(s) listed in the table below) and only the UV-resistant component(s) is/are listed in the table. Q-lab UVA 340 nm lamps were used.

TABLE 7
Summary of UV-resistance determined by colorimetry measurements
before and after different levels of UV exposure.

| | ΔE value after different UV exposure levels | | |
|---|---|---|---|
| Base resin + specific | 400 | 1000 | 5200 |
| UV resistant component | kJ/m² | kJ/m² | kJ/m² |
| 4% R-350 (TiO₂) | 3.9 | 6.2 | — |
| 10% R-350 | 3.8 | 4.8 | — |
| 4% R-350 + 10% EP4S | — | 0.2 | 0.4 |
| 4% R-350 + 10% 3070P | — | 5.9 | 9.8 |

Further UV resistance testing was performed on other formulations, using the same methodology. A summary of the ΔE value after different UV exposure levels is below in Table 8.

TABLE 8
Summary of UV-resistance determined by colorimetry measurements
before and after different levels of UV exposure.

| | ΔE value after different UV exposure levels | | | |
|---|---|---|---|---|
| Formulation | 120 kJ/m² | 200 kJ/m² | 1000 kJ/m² | 5200 kJ/m² |
| A | — | 8.3 | 16.6 | 18.2 |
| C | 9.4 | 11.4 | 20.1 | 27.3 |
| D | Not tested | 0.3 | 0.8 | 8.8 |
| E | Not tested | 0.7 | 1.5 | 9.1 |
| F | 9.5 | 11.6 | 20.5 | 27.3 |
| G | 7.7 | 8.1 | 17.7 | 22.8 |
| H | 9.1 | 8.6 | 18.8 | 27.7 |

### Example 5—Barrier Testing

A number of barrier layers were tested between a variety of surfacing films and epoxy-based carbon fiber composite layers, to determine which had the best combinations of ΔE value after UV exposure and crosshatch adhesion. The nylon barriers tested were a lower molecular weight proprietary nylon and a higher molecular weight nylon sold as Xantulayr® B (Nanolayr, Auckland, NZ). Polyimides (PI) tested include those sold as Kapton® (Dupont, Wilmington, DE); CP1, toughened CP1 (two layers of polyimide with a polyimide-infused PTFE matrix disposed in between), and black CP1 (polyimide with carbon nanoparticles), all sold by NeXolve (Huntsville, AL). Additional polyimides tested include those sold as Thermalbright® C (available from NeXolve). Two embodiments of Thermalbright® C, having different weights, are coated with vapor-deposited aluminum (VDA). A generic store-brand aluminum foil was also tested. The phenoxy resin was sold as Phenoxy PKHP-200 by Huntsman (Texas). A mylar (biaxially-oriented polyethylene terephthalate) film and a proprietary toughened epoxy film cured at 350° F. (“Toughened epoxy”) were also tested.

The ΔE value was tested after exposing each assembly to 1000 KJ/m² and 4000 KJ/m² of UVA light, and this value and the crosshatch adhesion score were determined according to methodologies discussed hereinabove. The specific combinations of formulations (“Form.”) and barriers, and relevant details are shown in Table 9, below. The results of the testing are discussed in Table 10. A “soft” barrier allows some epoxy to diffuse through it. A “hard” barrier completely prevents diffusion of the epoxy.

TABLE 9
Details of formulation/barrier setups tested

| | | | | | Barrier | | Total |
|---|---|---|---|---|---|---|---|
| | | | | Approx. | Areal | | Areal |
| | | Film Areal | | thickness | Weight | Barrier | Weight |
| Panel | Form. | Weight (gsm) | Barrier Film | (μm) | (gsm) | Type | (gsm) |
| 1 | F | 110.04 | None | n/a | n/a | — | 159.88 |
| 2 | F | 110.04 | Nylon - low MW | — | 2 | Hard | 161.88 |
| 3 | F | 110.04 | Nylon - high MW | — | 4.5 | Soft | 164.38 |
| 4 | F | 110.04 | Kapton | 50 | 72 | Hard | 231.88 |
| 5 | F | 110.04 | Phenoxy resin | 25-55 | — | Soft | — |
| 6 | F | 110.04 | Aluminum foil | 22.1 | 59.8 | Hard | 219.68 |
| 7 | F | 110.04 | CP1 PI | 6 | 8.8 | Soft | 168.68 |
| 8 | F | 110.04 | Toughened CP1 PI | 25.4 | 44.2 | Soft | 204.08 |
| 9 | F | 110.04 | Black CP1 PI | 25.4 | 37 | Soft | 196.88 |
| 10 | F | 110.04 | Thermalbright ® C | 25 | 40.5 | Soft | 200.38 |
| 11 | F | 110.04 | Mylar | 23 | 31.97 | Hard | 191.85 |
| 12 | F | 110.04 | Toughened epoxy | — | 46 | Soft | 205.88 |
| 13 | K | 76.46 | None | n/a | n/a | — | 126.30 |
| 14 | K | 76.46 | Mylar | 23 | 31.97 | Hard | 158.27 |
| 15 | K | 76.46 | Thermalbright ® C | 25 | 40.5 | Soft | 166.80 |
| 16 | K | 76.46 | Toughened CP1 PI | 25.4 | 44.2 | Soft | 170.50 |
| 17 | K | 76.46 | VDA-Coated | 25 | 40.184 | Soft | 166.49 |
| | | | Diffuse | | | | |
| | | | Thermalbright ® C | | | | |
| 18 | K | 76.46 | VDA-Coated | 25 | 47.594 | Soft | 173.90 |
| | | | Thermalbright ® C | | | | |
| 19 | L | 74.42 | None | n/a | n/a | — | 124.26 |
| 20 | L | 74.42 | Mylar | 23 | 31.97 | Hard | 156.23 |
| 21 | L | 74.42 | Thermalbright ® C | 25 | 40.5 | Soft | 164.76 |
| 22 | L | 74.42 | Toughened CP1 | 25.4 | 44.2 | Soft | 168.46 |
| 23 | L | 74.42 | VDA-Coated | 25 | 40.184 | Soft | 164.45 |
| | | | Diffuse | | | | |
| | | | Thermalbright ® C | | | | |
| 24 | L | 74.42 | VDA-Coated | 25 | 47.594 | Soft | 171.86 |
| | | | Thermalbright ® C | | | | |

TABLE 10
ΔE values and crosshatch adhesion values for the tested assemblies

| | | ΔE | ΔE | Dry |
|---|---|---|---|---|
| | | (1,000 | (4,000 | Crosshatch |
| Panel | | kJ/m² | kJ/m² | Adhesion |
| # | Form. | UVA) | UVA) | Score |
| 1 | F | 20.79 | 27.35 | 10 |
| 2 | F | 1.25 | 1.87 | 1 |
| 3 | F | 19.11 | 25.56 | 9 |
| 4 | F | 0.81 | 1.50 | 0 |
| 5 | F | 13.94 | 20.14 | 9 |
| 6 | F | 0.90 | 1.97 | 9 |
| 7 | F | 16.47 | 22.17 | 9 |
| 8 | F | 7.36 | 12.93 | 8 |
| 9 | F | 10.49 | 15.13 | 9 |
| 10 | F | 14.20 | 21.13 | 9 |
| 11 | F | 0.64 | 3.03 | 4 |
| 12 | F | 20.35 | 25.94 | 7 |
| 13 | K | 23.09 | 30.21 | 9 |
| 14 | K | 0.32 | 1.49 | 7 |
| 15 | K | 14.03 | 20.96 | 10 |
| 16 | K | 2.97 | 8.13 | 9 |
| 17 | K | 7.85 | 9.34 | 10 |
| 18 | K | 1.59 | 3.58 | 8 |
| 19 | L | 22.33 | 29.79 | 9 |
| 20 | L | 0.17 | 0.43 | 8 |
| 21 | L | 2.52 | 5.77 | 10 |
| 22 | L | 0.66 | 0.52 | 6 |
| 23 | L | 0.46 | 0.85 | 9 |
| 24 | L | 0.71 | 0.90 | 9 |

It can be seen that panel 23 (with a VDA-coated diffuse Thermalbright® C barrier) exhibited the best combination of ΔE values and adhesion, although other combinations also demonstrated good combinations of these properties.

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Although specific terms are employed herein, they are used in a generic and descriptive sense only and not for purposes of limitation. Each embodiment disclosed herein is contemplated as being applicable to each of the other disclosed embodiments. All combinations and sub-combinations of the various elements described herein are within the scope of the embodiments.

1. A surfacing composition comprising:
i) a curable resin component; and
ii) a UV reflectant;
wherein the curable resin component comprises an epoxy resin.

2. The surfacing composition of claim 1, wherein said curable resin component is present in an amount of about 30-99.98% by weight.

3. The surfacing composition of claim 1, wherein said epoxy resin is an epoxy-containing copolymer selected from the group consisting of epoxy methacrylate, epoxy acrylate, epoxy ester, siloxane epoxy, and epoxy/urethane copolymers, and any combination thereof.

4. The surfacing composition of claim 1, wherein said epoxy resin is selected from the group consisting of bisphenol-based epoxy resin, glycidyl amine, a novolak, an aliphatic epoxy, and a halogenated epoxy, and any combination thereof.

5. The surfacing composition of claim 1, wherein said curable resin component comprises epoxy-containing resin in an amount of 5-100% by weight; ether resin in amount of 0-95% by weight; and phenoxy resin in an amount of 0-95% by weight.

6. The surfacing composition of claim 1, further comprising at least one light stabilizer additive.

7. (canceled)

8. The surfacing composition of claim 6, wherein said light stabilizer additive is a hindered amine compound having the structure 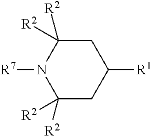
wherein R¹ has the structure —R³ₐ—R⁴_{b}—R⁵_{c}—R⁶,
wherein a, b, and c are each 0 or 1;
wherein R³ is selected from the group consisting of —OC(O)—, —C(O)O—, C₁₋₆ alkyl, and C₅₋₁₄ cycloalkyl;
wherein R⁴ is C₁₋₁₆ alkyl;
wherein R⁵ is selected from the group consisting of —OC(O)—, —C(O)O—, C₁₋₆ alkyl, and C₅₋₁₄ cycloalkyl;
wherein R⁶ is selected from the group consisting of H, C₁₋₆ alkyl, C₅₋₁₄ cycloalkyl, and 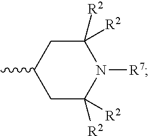
and
wherein each R² is independently selected from the group consisting of C₁₋₆ alkyl and C₅₋₁₄ cycloalkyl.

9.-15. (canceled)

16. The surfacing composition of claim 1, wherein said UV reflectant is present in an amount of 0.001-30% by weight.

17.-18. (canceled)

19. The surfacing composition of claim 1, further comprising a benzotriazole-based UV absorber, an accelerator, or a hardener.

20.-26. (canceled)

27. A prepreg, comprising a fabric impregnated or coated with the surfacing composition of claim 1.

28.-29. (canceled)

30. The prepreg of claim 1, wherein the prepreg is cured or partially-cured.

31. The cured or partially-cured prepreg of claim 30, wherein the surfacing composition or prepreg exhibits a ΔE value of less than 4.7 after being exposed to UV light at a total exposure level of 1000 or 5200 kJ/m² according to ASTM D2244-21.

32. A co-curable composite assembly, comprising
i) a co-curable composite material layer, comprising a carbon fiber having an uncured or partially-cured resin matrix infused therein; and
ii) a first prepreg of claim 27.

33. The co-curable composite assembly of claim 32, wherein said resin matrix is an epoxy resin matrix.

34. The co-curable composite assembly of claim 32, further comprising a conductive layer.

35. The co-curable composite assembly of claim 34, wherein the conductive layer is disposed between the composite material layer and the first prepreg; or wherein the first prepreg is disposed between the composite material layer and the conductive layer.

36. (canceled)

37. (canceled)

38. The co-curable composite assembly of claim 32, further comprising at least one barrier layer adjacent to one or more prepreg.

39. The co-curable composite assembly of claim 38, wherein the barrier layer comprises a metal, a polymer, a plastic, or any combination thereof.

40.-44. (canceled)

45. A composite assembly, comprising
i) a composite material layer, comprising a carbon fiber having a cured or partially-cured resin matrix infused therein; and
ii) a first prepreg of claim 27.

46.-57. (canceled)

58. A method of forming a co-cured composite assembly, said method comprising:
i) providing the co-curable composite assembly of claim 32; and
ii) co-curing the co-curable composite assembly,
thereby forming a co-cured composite assembly.
